(19) United States
(12) Patent Application Publication
(10) Pub. No.: US 2007/0050853 A1
(43) Pub. Date: Mar. 1, 2007

(54) Portable storage device and system of the same

(75) Inventor: Eun-hee Rhim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/508,937

(22) Filed: Aug. 24, 2006

(30) Foreign Application Priority Data
Aug. 31, 2005 (KR) 10-2005-0080831

(51) Int. Cl. H04L 9/32; H04N 7/16; G06F 17/30; G06F 12/14; G06F 7/04; G06K 9/00; G06F 11/30; H03M 1/68; H04K 1/00; H04L 9/00

(52) U.S. Cl. 726/27; 713/193; 726/31; 726/29

(57) ABSTRACT

A portable storage device and a system using the same are disclosed. The apparatus includes a first interface module for receiving metadata on content and authentication information on the content, a second interface for communicating with a player for playing the content, and a control module for transferring the received metadata and/or the authentication information to the second interface module, and for transferring the metadata and/or the authentication information to the player through the second interface module.

### CROSS-REFERENCE TO RELATED APPLICATION

This application claims priority from Korean Patent Application No. 10-2005-0080831 filed on Aug. 31, 2005 in the Korean Intellectual Property Office, the disclosure of which is incorporated herein in its entirety by reference.

### BACKGROUND OF THE INVENTION

1. Field of the Invention

Apparatuses consistent with the present invention relate to a portable storage device and a system of the same and, more particularly, to a portable storage device and a system of the same, whereby information having diverse forms and content can be stored for digital rights management (DRM), and various kinds of content can be used more easily.

2. Description of the Related Art

Recently, with the development of information technology, various kinds of information have been digitalized, and diverse types of networks have been developed. Accordingly, a method for providing easy and secure access of digital content is required.

That is, along with a method for accessing digital content more easily and conveniently, it is necessary to prevent the content from being distributed without permission or illegally copied by unauthorized persons.

Also, because the selection of a digital rights management (DRM) standard required to acquire or play paid-for digital content has been delayed, the activation of digital content has also been delayed.

In addition, the process of accessing digital content and information sources is complicated when a user accesses the digital content without using an input device such as a keyboard or a mouse, and this causes the user inconvenience.

Further, electronic files do not give users the impression that they possess digital content and have access to an information source.

### SUMMARY OF THE INVENTION

An aspect of the present invention is to enable a user to easily and conveniently use various kinds of content by storing information having diverse forms and contents in a categorized medium.

Additional aspects of the invention will be set forth in part in the description which follows and in part will become apparent to those having ordinary skill in the art upon examination of the following or may be learned from practice of the invention.

In order to accomplish these aspects, there is provided a portable information storing apparatus, according to the present invention, which comprises a first interface module for receiving content information on specified content and authentication information on the content; a second interface for communicating with a player for playing the content; and a control module for transferring the received content information and/or the authentication information to the second interface module, and transferring the content information and/or the authentication information to the player through the second interface module.

According to another exemplary embodiment of the present invention, there is provided a system, which comprises a portable storage device for storing content information on specified content and authentication information on the content; and a player for receiving the content information and/or the authentication information from the portable information storing apparatus, performing authentication for a content playback through an authentication center connected to the player through a network using the authentication information, and receiving the content from a content server connected to the player through the network using the content information.

According to yet another exemplary embodiment of the present invention, there is provided a player including: an interface module that receives metadata on content and authentication information on the content from a portable information storing apparatus for storing the metadata on the content and the authentication information on the content; an authentication module that performs an authentication to play the content through the authentication information by connecting to an authentication center; and a decoding module that plays the content according to the metadata if the authentication is successfully performed.

### BRIEF DESCRIPTION OF THE DRAWINGS

The above and other aspects of the present invention will become more apparent from the following detailed description taken in conjunction with the accompanying drawings, in which:

FIG. 1 is a view illustrating the construction of a DRM system according to an exemplary embodiment of the present invention;

FIG. 2 is a view illustrating the construction of a content provider according to an exemplary embodiment of the present invention;

FIG. 3 is a view illustrating the construction of a content cookie according to an exemplary embodiment of the present invention;

FIG. 4 is a view illustrating the construction of a player according to an exemplary embodiment of the present invention; and

FIG. 5 is a view illustrating a data architecture stored in a content cookie according to an exemplary embodiment of the present invention.

### DETAILED DESCRIPTION OF THE EXEMPLARY EMBODIMENTS OF THE INVENTION

Hereinafter, exemplary embodiments of the present invention will be described in detail with reference to the accompanying drawings. The aspects and features of the present invention and methods for achieving the aspects and features will become apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the whole description of the present invention, the same reference numerals are used for the same elements across various figures.

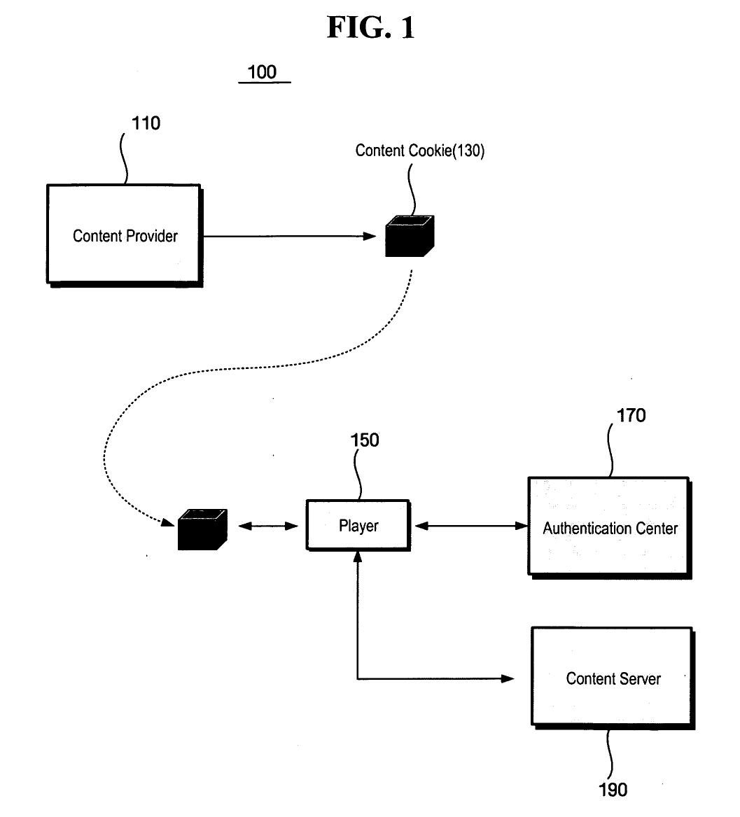

FIG. 1 is a view illustrating the construction of a system according to an exemplary embodiment of the present invention.

Referring to FIG. 1, the system according to the present invention includes a content provider 110, a content cookie 130 provided by the content provider 110, a player 150 that communicates with the content cookie 130 and plays the corresponding content according to the information stored in the content cookie 130, a content server 190 for providing the player 150 with the content, and an authentication center 170 for authenticating the content playback.

The content cookie 130 may store diverse forms of authentication information for DRM, and it may also store the corresponding content.

A user may carry the content cookie 130 provided by the content provider 110, and may play the corresponding content by accessing a player 150 that can accept the content cookie 130.

The player 150 performs an authentication procedure via the authentication center 170 by using the authentication information stored in the content cookie 130. When the authentication is completed, the player 150 receives the corresponding content from the content server 190 and plays it. In this case, the authentication center 170 and the content server 190 may be separately constructed, or they may be combined into one system.

The construction and operation of the content provider 110, the content cookie 130, and the player 150 is described in detail in the following.

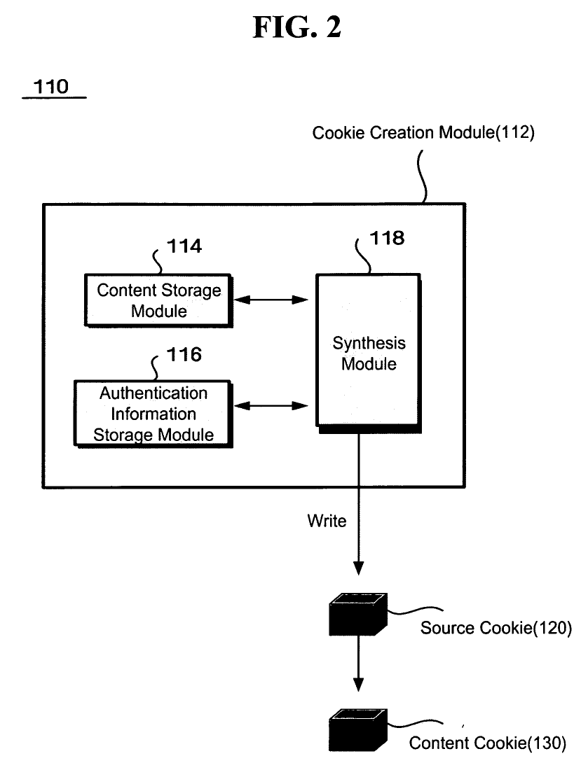

FIG. 2 is a view illustrating the construction of the content provider according to an exemplary embodiment of the present invention.

Referring to FIG. 2, the content provider 110 includes a cookie creation module 112 for creating information to be stored in a cookie, and a source cookie 120 for storing the authentication information. The source cookie 120 is a cookie lacking authentication information of specified content, and the content cookie 130 is a cookie that stores the authentication information.

The cookie creation module 112 includes a content storage module 114, an authentication information storage module 116, and a synthesis module 118.

Specified content is stored in the content storage module 114, and the authentication information for the content is stored in the authentication information storage module 116.

The synthesis module 118 uses the stored content and authentication information and produces data that can be written to the source cookie 120. Then, the content cookie 130 is produced by writing the produced data in the source cookie 120.

In this case, since the synthesis module 118 may generate the cookie information by using only the authentication information stored in the authentication information storage module 116, the content may not be stored in the content cookie 130, but only the authentication information of the content may be stored in the content cookie.

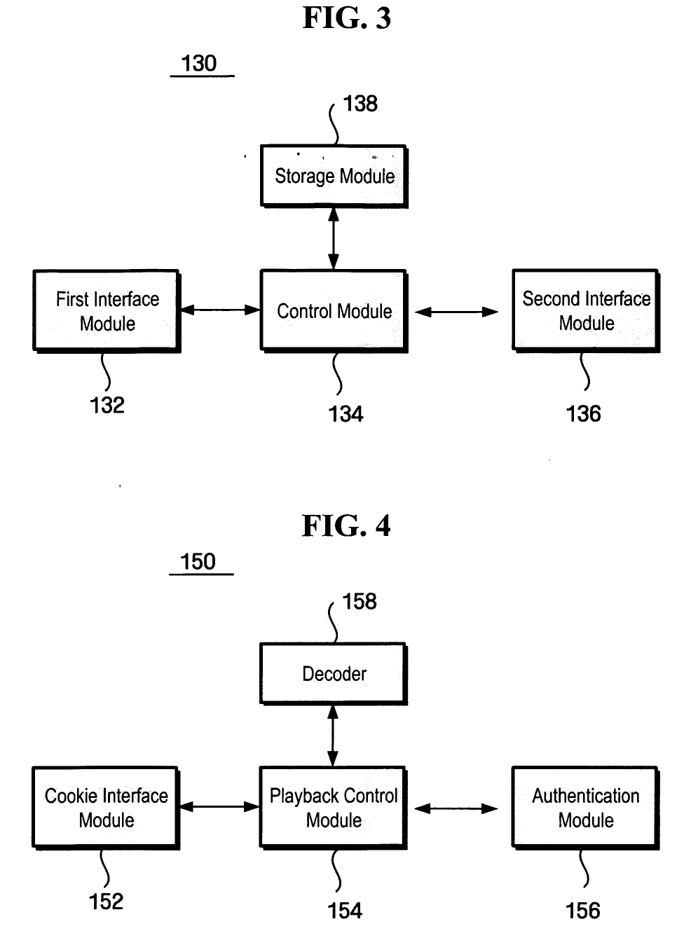

FIG. 3 is a view illustrating the construction of the content cookie according to an exemplary embodiment of the present invention.

Referring to FIG. 3, the content cookie 130 includes a control module 134, a first interface module 132, a second interface module 136, and a storage module 138.

The first interface module 132 is a module that receives the cookie information produced by the cookie creation module 112, and transfers the input cookie information to the control module 134 through the first interface module 132. The control module 134 stores the transferred cookie information in the storage module 138.

The storage module 138 may include a storage medium such as a flash memory or a mini-optical disc. Alternatively, the storage module 138 may be formed on a surface of the content cookie 130. Further, the storage module 138 may be formed using a microbe or bio-neurotransmitter. Meanwhile, the data architecture of the cookie information stored in the storage module 138 is described in detail with reference to FIG. 3 in the following.

The second interface module 136 is a module for serving as a communication interface between the control module 134 and the player 150. The control module 134 transfers the metadata on the content to be played or the authentication information of the content to the player 150 via the second interface module 136.

If the corresponding content is stored in the storage module 138, the control module 134 transfers the content to the player 150 through the second interface module 136.

The second interface module 136 may be a radio interface such as UWB or RFID that connects to the player 150 in order to transfer the information stored in the storage module 138 to the player 150. Accordingly, the control module may communicate with the player 150 via a radio interface.

The second interface module 136 can also be a USB interface.

The content cookie 130 can also be implemented as a USB storage device, a coin, an accessory of a mobile phone, a key holder, a bead, a ring, a biscuit, or a card. The player 150, which communicates with the content cookie 130, may have a funnel-shaped portion, a scale-support portion, or a groove, so that the content cookie can be laid on or inserted into the player 150.

FIG. 4 is a view illustrating the construction of the player according to an exemplary embodiment of the present invention.

Referring to FIG. 4, the player 150 includes a cookie interface module 152, a playback control module 154, an authentication module 156, and a decoder 158.

The cookie interface module 152 is a module that connects to the content cookie 130 in order to communicate with it, and it may be formed to suit the form of the content cookie 130.

For example, if the content cookie 130 is formed as a touch type, the cookie interface module 152 must recognize the content cookie 130 as an input device of the player 150, and detect the surface state of the content cookie 130.

If the content cookie 130 transfers information using a radio frequency, the player 150 should be made in the form of a radio interface that is capable of finding and recognizing the content cookie 130.

The cookie interface module 152 may be implemented using RFID, UWB, or a USB interface or radio USB interface.

If the playback control module 154 receives the authentication information from the content cookie 152 through the cookie interface module 152, the playback control module 154 transfers the received authentication information to the authentication module 156. The authentication module 156 is connected to the authentication center 170 through a network interface (not shown), which is separate from the cookie interface module 152, and performs the authentication of the corresponding content.

When the authentication of the player or the corresponding content is successfully completed by the authentication module 156, the decoder 158 plays the corresponding content under the control of the playback control module 154.

In this case, the playback control module 154 receives the corresponding content from the content server 190 through the network interface (not shown) in order to provide the content to the decoder 158, or receives the corresponding content from the content cookie 130 in order to provide the content to the decoder 158.

The content cookie 130 and the player 150 are connected in order to transfer data through the following procedure.

The content cookie 130 can be connected to the player 150 in various ways. For example, in the case of a contact type connection, the content cookie 130 is connected to the player 150 through an input port of the player 150, or a support of the player 150 on which the content cookie 130 is laid. In the case of a radio connection, the content cookie 130 and the player 150 should be positioned a predetermined distance from each other.

The player 150 recognizes the content cookie 130 connected thereto. In the case of the contact-type connection, the player 150 recognizes the connected content cookie 130 through the variation of light quantity, variation of weight, or electric current. In the case of the radio connection, the player 150 recognizes the connected content cookie 130 through a specified sync signal, variation of electric current, or the like.

After the player 150 recognizes the content cookie 130 connected thereto, the player 150 receives the cookie information from the recognized content cookie 130.

In this case, the cookie information includes various kinds of information such as general information on the content, authentication information, information on the provider of the content cookie 130, and the type of the content cookie 130. In addition, the cookie information may include the content itself.

If all the cookie information is transferred from the content cookie 130 to the player 150, the player 150 is disconnected from the content cookie 130.

After the player 150 receives the information stored in the content cookie 130, the player may operate as follows.

In this case, it is assumed that paid-content access information and authentication information, such as DRM key information, are stored in the content cookie. The access information and the authentication information are stored in a format that the player 150 can recognize. The authentication information may include limit information such as the frequency of content playback, playback time and use period.

The player 150 accesses the content server 190, and requests access to a content list designated by the content cookie 130.

In this case, the player 150 may perform the authentication via the authentication center 170. If the authentication is completed, the player 150 may stream or download the corresponding content according to the rights defined by the content cookie 130. Then, the player 150 reproduces the content data transferred from the content server 190.

The function provided by the content cookie 130 may differ for each content cookie; an example of which is explained in the following.

A user-preferences cookie provides a hyperlink list and basic use information on the user of the player 150. The user may manage the player environment and a favorite channel list (favorite information), and record them in the user-preferences cookie. Even if the player is changed, the user-preferences cookie can maintain the user's preferences.

A remote-system-access-and-control information cookie includes an access method and information for access when the user intends to access the remote system through the player 150. Such information includes an access point of a remote system, a user authentication key, a permitted system utility, and others.

When the player 150 attempts to access the access point of the remote system, and succeeds in accessing the remote system by using the user authentication key, the player 150 displays a menu permitted by the remote system on a display screen of the player 150, and waits for user input.

A player access information cookie is used to determine whether the user who intends to use the player is a permitted person. The player determines whether the access code received from the player-access information cookie is a permitted code. If the access code is not a permitted code, the player stops its operation and returns to its original state.

A target-access-point-access information cookie includes information making it possible to access a target server through diverse network interfaces. Such information includes the network type of the target access point, a network channel, a network access key, a name of the target access point, a user authentication key of the target access point, and target-access-page information.

The network type of the target access point includes an analog TV channel, a DMB/satellite channel, a cable TV channel, and information on the target device.

When a pay-for-service network is accessed, a pre-paid network-access information cookie may be used as a substitute for cash. In this case, the paid network may be an analog TV channel, a DMB/satellite channel, a cable TV channel, a VoIP phone service, and others.

The validity of the pre-paid access right is determined by information obtained from the pre-paid-network-access information cookie. If the pre-paid access right is valid, the player can provide the access and service of a designated network to the user.

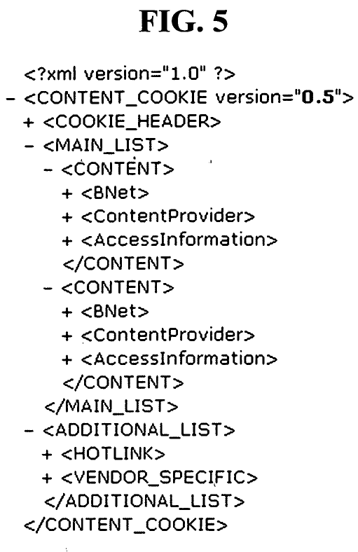

FIG. 5 is a view illustrating the data architecture of the content cookie according to an exemplary embodiment of the present invention. In FIG. 5, the data architecture is illustrated using the extensible mark-up language (XML).

The XML file of FIG. 5 is transferred from the content cookie 130 to the player 150 at the moment the content cookie 130 is connected to the player 150.

Referring to FIG. 5, the content cookie includes a “COOKIE_HEADER” element, a “MAIN_LIST” element, and an “ADDITIONAL_LIST” element.

The “COOKIE_HEADER” element includes general information of the content cookie such as an identification number, a type, an object to which the content cookie is applied, and others. The player judges whether the job requested in the “COOKIE_HEADER” element can be performed, and prepares for the job.

The “COOKIE_HEADER” element may have the following structure.

```
<COOKIE_HEADER><SerialNumber>
20050825_Suwon_Korea_2kfigu5yeh12ls0oekgu
      </SerialNumber>
        <Type>A1</Type>
        <ItemCapability>
            <BNet>Net_1029</BNet>
            <ServiceProvider>SV10</ServiceProvider>
        <ContentProvider>CV_G1_5039:CV_G5_012
        </ContentProvider>
        <ContentType>Multimedia:LiveTV</ContentType>
      </ItemCapability>
      </COOKIE_HEADER>
```

The “MAIN_LIST” element includes actual content information, a method of accessing the content information, an authentication key, and others. The player refers to information contained in the “MAIN_LIST” on the player that is used to play the corresponding content. FIG. 5 shows that the “MAIN_LIST” element contains information regarding two kinds of content.

An exemplary structure for indicating one kind of content among the “MAIN_LIST” element is as follows.

```
<CONTENT>
<BNet>
    <NetId>Terrestrial_DMB</NetId>
    <ServiceProvider>None</ServiceProvider> <!-- KBS -->
    <AccessKey>None</AccessKey>
</BNet>
<ContentProvider>
    <CPId>CV_G5_012</CPId> <!-- SBS -->
    <AccessKey_CPGate>Paid_Cookie</AccessKey_CPGate>
    <AccessKey_CPLogOn>023094_dkcmf</AccessKey_CPLogOn>
</ContentProvider>
<AccessInformation>
    <ContentType>Multimedia</ContentType>
<ContentName>None:Fashion_70s_27:Video</ContentName>
<AccessPage>drama/mon/fashion/ekdfugjsh_00027.abc</AccessPage>
<AccessType>AT_TP_0012</AccessType> <!-- EX: 3-rd party player +
HTTP streaming -->
    <AccessPlayer>Turbo:+v029:AVI511_AC3</AccessPlayer>
    <AccessProperty>
        <BasicAccess>RW---:s3o</BasicAccess>
        <AdditionalAccess>mxcxmpo</AdditionalAccess>
        <ForbiddenAccess>d04c04f7</ForbiddenAccess>
        <AccessUnit>Date</AccessUnit>
        <AccessMax>Till:20071231</AccessMax>
    </AccessProperty>
</AccessInformation>
</CONTENT>
```

The “ADDITIONAL_LIST” element is optional information that may expand the content of a vendor or contain information on a user, if necessary.

An exemplary structure of the “ADDITIONAL_LIST” element is as follows.

```
    <ADDITIONAL_LIST>
    <HOTLINK>
        <Type>Express_Gold@High_Class_Paid</Type>
    <EntryPath>ff@SV10:express_channel10395</EntryPath>
        <EntryKey>2kfigu5yeh12ls0oekgu</EntryKey>
</HOTLINK>
<VENDOR_SPECIFIC>
        <VENDOR>
            <CPId>CV_G5_012</CPId>
    <MaxBandWidth>7M:COS_level70:QoS_c938_c8283
            </MaxBandWidth>
        <DeviceKey>kau3qp49skjjflakhr123a</DeviceKey>
    </VENDOR>
</VENDOR_SPECIFIC>
  </ADDITIONAL_LIST>
```

As described above, according to the present invention, various kinds of content can be used more easily and conveniently through a categorized medium that allows information having diverse forms and content to be protected by DRM.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A portable storage device comprising:
a first interface module for receiving metadata on content and authentication information on the content;
a second interface for communicating with a player for playing the content; and
a control module for transferring the received metadata and/or the authentication information to the second interface module, and transferring the metadata and the authentication information to the player through the second interface module.

2. The portable storage device as claimed in claim 1, further comprising a storage module for storing the received metadata and the authentication information from the first interface module.

3. The portable storage device as claimed in claim 2, wherein the control module transfers the metadata and/or the authentication information stored in the storage module to the player.

4. The portable storage device as claimed in claim 1, wherein the second interface module includes a radio interface module that performs a radio communication with the player.

5. The portable storage device as claimed in claim 1, wherein the authentication information includes digital rights management (DRM) key information.

6. The portable storage device as claimed in claim 1, wherein the authentication information includes limit information on the content playback.

7. A system comprising:
a portable storage device for storing metadata on content and authentication information on the content; and
a player for receiving the metadata and/or the authentication information from the portable storage device, performing, using the authentication information, an authentication for a content playback through an authentication center connected to the player through a network, and receiving, using the metadata, the content from a content server connected to the player through the network.

8. The system as claimed in claim 7, wherein the portable storage device comprises:
a first interface module for receiving the metadata and/or the authentication information;
a second interface for communicating with a player for playing the content; and
a control module for transferring the received metadata and/or the authentication information to the second interface module, and transferring the metadata and/or the authentication information to the player through the second interface module.

9. The system as claimed in claim 8, wherein the portable storage device further comprises a storage module for storing the metadata and/or the authentication information received from the first interface module.

10. The system as claimed in claim 9, wherein the control module transfers the metadata and/or the authentication information stored in the storage module to the player.

11. The system as claimed in claim 8, wherein the second interface module includes a radio interface module that performs a radio communication with the player.

12. The system as claimed in claim 7, wherein the authentication information includes digital rights management (DRM) key information.

13. The system as claimed in claim 7, wherein the authentication information includes limit information on the content playback.

14. A player comprising:
an interface module that receives metadata on content and authentication information on the content from a portable information storing apparatus for storing the metadata on the content and the authentication information on the content;
an authentication module that performs an authentication to play the content through the authentication information by connecting to an authentication center; and
a decoding module that plays the content according to the metadata if the authentication is successfully performed.

15. The player as claimed in claim 14, further comprising:
a playback control module that receives the content from a content providing server according to the metadata on the content, and provides the content to the decoding module.

16. The player as claimed in claim 14, wherein the portable information storing apparatus includes:
a first interface module for receiving the metadata and the authentication information;
a second interface module for communicating with the player for playing the content; and
a control module for transferring the received metadata and the authentication information to the second interface module, and transferring the metadata and the authentication information to the player through the second interface module.

17. The player as claimed in claim 16, wherein the second interface module includes a radio interface module performing a radio communication with an interface module of the player.

18. The player as claimed in claim 14, wherein the authentication information includes digital rights management (DRM) key information.

19. The player as claimed in claim 14, wherein the authentication information includes limit information on the content playback.
